(19) United States
(12) Patent Application Publication
(10) Pub. No.: US 2024/0182103 A1
(43) Pub. Date: Jun. 6, 2024

(54) Control Unit for Arrangement on a Steering Wheel in a Motor Vehicle

(71) Applicant: Bayerische Motoren Werke Aktiengesellschaft, Muenchen (DE)

(72) Inventors: Stefan BAST, Muenchen (DE); Benjamin Brueck, Irschenberg (DE); Hermann Dell, Muenchen (DE); Thomas Hilger, Iffeldorf (DE); Christian Knoll, Muenchen (DE); Stephan Mueller, Muenchen (DE); Martin Schmid, Muenchen (DE); Hannes Trapp, Muenchen (DE)

(21) Appl. No.: 18/524,938

(22) Filed: Nov. 30, 2023

(30) Foreign Application Priority Data
Dec. 1, 2022 (DE) 10 2022 131 903.2

(51) Int. Cl. B62D 1/04

(52) U.S. Cl. CPC B62D 1/046

(57) ABSTRACT

A control unit for arrangement on a steering wheel in a motor vehicle includes a main body with a central plateau, an L2 operating element which is designed to activate a driver assistance system having a degree of automation corresponding to the SAE level 2, and an L3 operating element which is designed to activate a driver assistance system having a degree of automation corresponding to the SAE level 3. The control unit is characterized in that the L2 operating element is recessed with respect to the central plateau and in that the L3 operating element is raised in the manner of a relief with respect to the central plateau.

### CROSS REFERENCE TO RELATED APPLICATION

This application claims priority under 35 U.S.C. § 119 from German Patent Application No. DE 10 2022 131 903.2, filed Dec. 1, 2022, the entire disclosure of which is herein expressly incorporated by reference.

### BACKGROUND AND SUMMARY

The present invention relates to a control unit for arrangement on a steering wheel in a motor vehicle, to a steering wheel having a control unit, and to a motor vehicle having a control unit. The invention therefore relates to the field of operating elements for motor vehicles.

Motor vehicles typically have one or more control unit(s) arranged on the steering wheel, which control unit(s) can be operated with the fingers while the hands hold the steering wheel. This allows functions to be actuated by means of the control units without the need to remove the hands from the steering wheel for this purpose. In order to operate certain control units, however, it can be necessary for a driver to direct the gaze onto the control unit for a visual check in order to ensure that the desired function is carried out with the intended actuation of the control unit. This can be the case, in particular, when the driver is not familiar or is only slightly familiar with the operating concept of the vehicle, or because the control unit does not permit a sufficient distinction between the individual operating elements and the functions associated therewith. Reliable operation of the correct operating elements is of great significance, in particular, for such operating elements which control particularly safety-relevant functions. This can include, for example, functions which partially or completely transfer the control of the motor vehicle to a corresponding driver assistance system. It can be particularly desirable to provide an intuitive operability of such operating elements in favor of reliable operation.

Against the background of this related art, the problem addressed by the present invention is to provide an improved control unit which is suitable for enhancing the related art. A specific embodiment of the invention can solve the problem of reducing the risk of maloperation of operating elements arranged on the steering wheel of a motor vehicle.

The problem is solved by the features of the respective independent claims. The dependent claims describe optional developments of the invention.

The problem is solved by a control unit for arrangement on a steering wheel in a motor vehicle. The control unit includes a main body having a central plateau. In addition, the control unit includes an L2 operating element which is designed to activate a driver assistance system having a degree of automation corresponding to the SAE level 2, and an L3 operating element which is designed to activate a driver assistance system having a degree of automation corresponding to the SAE level 3. The operating element is characterized in that the L2 operating element is recessed with respect to the central plateau and in that the L3 operating element is raised in the manner of a relief with respect to the central plateau.

A control unit can include multiple operating elements, such as, for example, buttons, levers and/or touch elements, the control unit being designed to provide the operating elements at a specified position such that the driver or user of the motor vehicle can actuate the operating elements. The control unit being designed to be arranged on a steering wheel means that the control unit is intended to be arranged on or next to a steering wheel in the motor vehicle such that the driver can actuate the operating elements of the control unit while the hands are located on the steering wheel.

The main body can be in the form of a relief. This means the main body can have a three-dimensional shape which makes it easy for the user or the driver to feel certain areas or elements. For this purpose, the main body can have, in particular, raised areas, recesses, beveling, edges, joints, corners, roughenings and/or similar designs and/or surface finishes which the driver or user can feel.

The central plateau is a region of the main body, which is a platform optionally facing the driver in a central region of the control unit and on which operating elements formed there are particularly exposed and easily accessible to the driver. The upper chamfered edge is, optionally, a beveling on the upper end of the central plateau. The lower chamfered edge is, optionally, a beveling on the lower end of the central plateau.

The SAE level 2 and SAE level 3 degrees of automation of the driver assistance system can correspond to the SAE J3016 standard. The operating element for activating these degrees of automation can also be used to deactivate the particular degree of automation by actuating the operating element again, provided the particular degree of automation is activated.

The invention offers the advantage that a clear allocation of the operating elements according to the functions to which the operating elements are assigned can be achieved and thus clarity can be enhanced and intuitive operation can be made possible. In particular, due to the selected arrangement of the L2 operating element and of the L3 operating element, these can be set apart from any other operating elements such that a risk of inadvertently actuating these is reduced. Due to the fact that the L2 operating element is recessed and the L3 operating element is raised in the manner of a relief, a risk of confusing the two operating elements can also be reduced. In addition, blind operability can be improved as a result, thereby allowing the driver to reliably actuate the desired operating element also without a visual check. As a result, the risk of maloperation of the driver assistance system can be reduced and, consequently, safety can be enhanced.

Furthermore, the control unit can include operating elements which are arranged on the central plateau and are designed to change a set speed of a cruise control of the motor vehicle. This arrangement offers a design which is clear and intuitive for the driver, since the operating elements for changing the set speed are closely associated with the L2 operating element and the L3 operating element in terms of theme. The operating elements for changing the set speed can be raised in the manner of a relief with respect to the central plateau. This can be advantageous with respect to locating them without a visual check.

The control unit can be designed to be arranged on the left side of the steering wheel such that the operating elements of the control unit can be operated using the left hand while the left hand remains on the steering wheel.

Furthermore, the main body can have an upper chamfered edge and a lower chamfered edge, which are adjacent to the central plateau, wherein at least one further operating element is arranged on the upper chamfered edge and on the lower chamfered edge in each case. The upper chamfered edge and the lower chamfered edge can be chamfered with respect to the central plateau. This can facilitate locating the upper chamfered edge and/or the lower chamfered edge and the operating elements arranged there. In addition, this can support the haptic delimitation with respect to the central plateau such that the delimitation of the zones which are optionally connected thereto can be improved. An operating element arranged on the upper chamfered edge can be optionally designed to activate a parking assistance system of the motor vehicle. An operating element arranged on the lower chamfered edge can be designed to confirm an input or a proposed setting.

Optionally, the L2 operating element is arranged in a recess with respect to the central plateau. Optionally, the main body can be chamfered in a region adjacent to the recess such that the chamfer extends toward the recess. This can support locating the L2 operating element blindly since the recess and, optionally, the chamfered adjacent region, which extends toward the recess, lead to the L2 operating element.

Furthermore, the control unit can include one further operating element which is arranged on the central plateau and is designed to activate a speed limiter of the motor vehicle. In addition, an operating element which can activate a steering and lane guidance assistant can be arranged on the central plateau. The operating elements for the steering and lane guidance assistant and for the speed limiter are arranged such that the L3 operating element, which is raised in the manner of a relief, is arranged between these operating elements. As a result, a haptic barrier can be created between these two operating elements and thus the risk of maloperation can be reduced. As a result, safety in traffic can be enhanced.

Furthermore, a steering wheel is provided, which is characterized in that the steering wheel includes at least one above-described control unit. The description provided above relating to the control unit is also to be considered to be disclosed for a steering wheel, and vice versa.

Furthermore, a motor vehicle is provided, which is characterized in that the motor vehicle includes at least one above-described control unit. The description provided above relating to the control unit is also to be considered to be disclosed for a motor vehicle, and vice versa.

The motor vehicle can be a passenger car, in particular an automobile, or a commercial vehicle such as a truck. The motor vehicle can be designed to at least partially and/or at least intermittently take over longitudinal control and/or transverse control during automated driving. The automated driving can take place such that the moving of the motor vehicle takes place (largely) autonomously. The automated driving can be controlled at least partially and/or intermittently by the data processing device.

It is understood that the features and embodiments mentioned above and explained in the following are to be considered to be disclosed not only in the respective explicitly mentioned combinations, but rather other technically meaningful combinations and embodiments of the disclosure are also included.

Optional embodiments are described in the following with reference to the figures.

### BRIEF DESCRIPTION OF THE DRAWINGS

FIG. 1 shows a control unit according to one optional embodiment for arrangement on a steering wheel in a motor vehicle;

FIG. 2 shows a schematic view of a motor vehicle according to one optional embodiment.

Identical reference signs are used in the figures for identical or similar elements. In the description of the figures, reference signs are indicated in some cases even though the particular element may be apparent only in other figures.

### DETAILED DESCRIPTION OF THE DRAWINGS

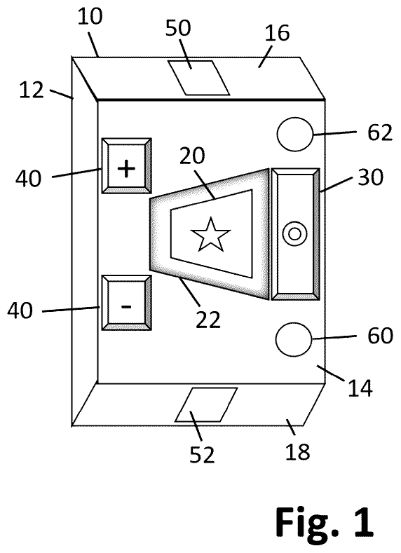

FIG. 1 shows a control unit 10 according to one optional embodiment for arrangement on a steering wheel 100 in a motor vehicle 100. The control unit 10 includes a main body 12 having a central plateau 14. The control unit 10 also includes an L2 operating element 20 which is designed to activate a driver assistance system having a degree of automation corresponding to the SAE level 2. The control unit 10 also includes an L3 operating element 30 which is designed to activate a driver assistance system having a degree of automation corresponding to the SAE level 3. The control unit 10 is characterized in that the L2 operating element 20 is recessed with respect to the central plateau 14 and in that the L3 operating element 30 is raised in the manner of a relief with respect to the central plateau 14.

Furthermore, the control unit 10 can include operating elements 40 which are arranged on the central plateau 14 and are designed to change a set speed of a cruise control of the motor vehicle 200. The operating elements 40 are adjacent to the L3 operating element 30. Due to the thematic association of these operating elements 40 with the L2 operating element 20 and the L3 operating element 30, an intuitive operating concept can be provided. The operating elements 40 for changing the set speed with respect to the central plateau 14 are raised in the manner of a relief according to the embodiment shown. This can facilitate locating these operating elements 40 without a visual check.

The main body 12 can also have an upper chamfered edge 16 and a lower chamfered edge 18 which are adjacent to the central plateau 14. At least one further operating element can be optionally arranged on the upper chamfered edge 16 and on the lower chamfered edge 18 in each case. According to the embodiment shown, an operating element 50, which is designed to activate a parking assistance system of the motor vehicle 200, can be arranged on the upper chamfered edge 16. The arrangement permits easy accessibility of the operating element 50 for the driver and, at the same time, haptic separation from the operating elements on the central plateau 14 due to the arrangement on the upper chamfered edge 16.

Furthermore, the control unit 10 can have an operating element 52 which is arranged on the lower chamfered edge 18, the operating element 52 being designed to confirm an input or a proposed setting. The arrangement permits easy accessibility of the operating element 52 for the driver and, at the same time, haptic separation from the operating elements on the central plateau 14 due to the arrangement on the lower chamfered edge 18.

The L2 operating element 20 can be arranged in a recess 22. Optionally, the main body 12 can be chamfered in a region adjacent to the recess 22 such that the chamfered extends toward the recess 22. This can offer the advantage that, due to the arrangement of the L2 operating element 20 in the recess 22, the risk of an inadvertent actuation, for example, by brushing over the L2 operating element 20, can be reduced and, in this way, safety can be enhanced. In addition, haptic guidance for a finger and/or a thumb of the driver can be achieved due to the recess 22 and, in particular, due to the optional beveling of the central plateau 14 in the region adjacent to the recess 22.

Furthermore, the control unit 10 can include an operating element 60 which is arranged on the central plateau 14 and is designed to activate a speed limiter of the motor vehicle 200. In addition, an operating element 62, which can activate a steering and lane guidance assistant, can be arranged on the central plateau 14. The operating elements 60 and 62 for the steering and lane guidance assistant and for the speed limiter are arranged such that the L3 operating element 30, which is raised in the manner of a relief, is arranged between these operating elements 60, 62. As a result, a haptic barrier can be created between these two operating elements 60, 62 and thus the risk of maloperation can be reduced. As a result, safety in traffic can be enhanced.

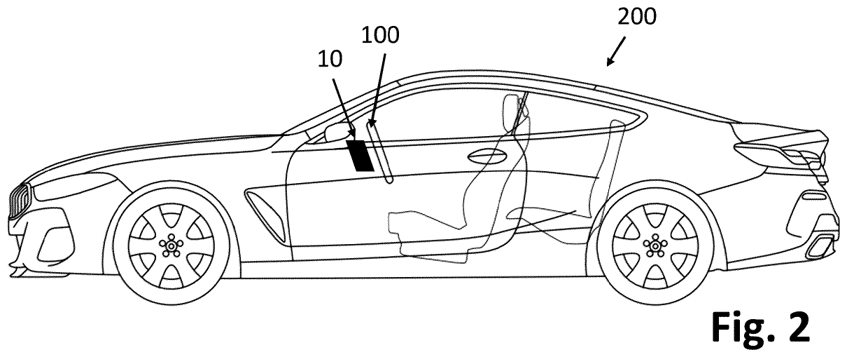

FIG. 2 shows a schematic view of a motor vehicle 200 according to one optional embodiment including a steering wheel 100, the steering wheel 100 having a control unit 10 according to the optional embodiment shown in FIG. 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

10 control unit
12 main body
14 central plateau
16 upper chamfered edge
18 lower chamfered edge
20 L2 operating element
22 recess
30 L3 operating element
40 operating element (for changing the set speed)
50 operating element (for activating the parking assistance system)
52 operating element (for input confirmation)
60 operating element (for activating the speed limiter)
62 operating element (for activating the steering and lane guidance assistant)
100 steering wheel
200 motor vehicle.

What is claimed is:

1. A control unit for arrangement on a steering wheel in a motor vehicle, the control unit comprising:
a main body with a central plateau;
an L2 operating element which is designed to activate a driver assistance system having a degree of automation corresponding to SAE level 2; and
an L3 operating element which is designed to activate a driver assistance system having a degree of automation corresponding to SAE level 3;
wherein the L2 operating element is recessed with respect to the central plateau and the L3 operating element is raised in a manner of a relief with respect to the central plateau.

2. The control unit according to claim 1, further comprising:
further operating elements which are arranged on the central plateau and are designed to change a set speed of a cruise control of the motor vehicle.

3. The control unit according to claim 2, wherein
the further operating elements for changing the set speed are raised in the manner of a relief with respect to the central plateau.

4. The control unit according to claim 1, wherein
the main body further comprises an upper chamfered edge and a lower chamfered edge, which are adjacent to the central plateau, and
at least one additional operating element is arranged on the upper chamfered edge and at least one additional operating element is arranged on the lower chamfered edge.

5. The control unit according to claim 4, wherein
one of the additional operating elements, which is arranged on the upper chamfered edge, is designed to activate a parking assistance system of the motor vehicle.

6. The control unit according to claim 5, wherein
one of the additional operating elements, which is arranged on the lower chamfered edge, is designed to confirm an input or a proposed setting.

7. The control unit according to claim 3, wherein
the L2 operating element is arranged in a recess, and
the main body is chamfered in a region adjacent to the recess such that a chamfer extends toward the recess.

8. The control unit according to claim 1, further comprising:
an operating element, which is arranged on the central plateau, and is designed to activate a speed limiter of the motor vehicle.

9. An operating device for a motor vehicle, comprising:
a steering wheel; and
a control unit arranged on the steering wheel, the control unit comprising:
a main body with a central plateau;
an L2 operating element which is designed to activate a driver assistance system having a degree of automation corresponding to SAE level 2; and
n L3 operating element which is designed to activate a driver assistance system having a degree of automation corresponding to SAE level 3;
wherein the L2 operating element is recessed with respect to the central plateau and the L3 operating element is raised in a manner of a relief with respect to the central plateau.

10. A motor vehicle comprising an operating device according to claim 9.
